(19) United States
(12) Patent Application Publication
(10) Pub. No.: US 2013/0191120 A1
(43) Pub. Date: Jul. 25, 2013

(54) CONSTRAINED SOFT DECISION PACKET LOSS CONCEALMENT

(71) Applicant: Broadcom Corporation, Irvine, CA (US)

(72) Inventors: Robert W. Zopf, Rancho Santa Margarita, CA (US); Juin-Hwey Chen, Irvine, CA (US)

(73) Assignee: BROADCOM CORPORATION, Irvine, CA (US)

(21) Appl. No.: 13/748,949

(22) Filed: Jan. 24, 2013

Related U.S. Application Data
(60) Provisional application No. 61/752,840, filed on Jan. 15, 2013.
(60) Provisional application No. 61/706,328, filed on Sep. 27, 2012.
(60) Provisional application No. 61/590,015, filed on Jan. 24, 2012.

(51) Int. Cl. G10L 19/005

(52) U.S. Cl. CPC G10L 19/005
USPC 704/228

(57) ABSTRACT

Methods, systems, and apparatuses for performing packet loss concealment are disclosed. In response to determining that an encoded frame representing a segment of a signal is bad, an encoded parameter within the encoded frame is decoded based on bit information (such as soft bit information) associated with the encoded parameter to obtain a decoded parameter. Whether the decoded parameter violates a parameter constraint is determined. If a parameter constraint violation is detected, an estimate of the decoded parameter is generated. Either the decoded parameter or estimate of the decoded parameter is passed to a decoder for use in decoding the encoded frame.

### CROSS REFERENCE TO RELATED APPLICATIONS

This application claims priority to the following provisional applications, each of which is incorporated by reference herein: U.S. Provisional Patent Application No. 61/590,015, filed Jan. 24, 2012, U.S. Provisional Patent Application No. 61/706,328, filed Sep. 27, 2012, and U.S. Provisional Patent Application No. 61/752,840, filed Jan. 15, 2013.

This application is also related to the following U.S. patent applications, each of which also claims the benefit of U.S. Provisional Patent Application Nos. 61/590,015 and 61/706,328, and each of which is incorporated by reference herein:

U.S. patent application Ser. No. ______ (Attorney Docket No. A05.01890001), filed on even date herewith and entitled “Joint Source Channel Decoding Using Parameter Domain Correlation”;

U.S. patent application Ser. No. ______ (Attorney Docket No. A05.01900001), filed on even date herewith and entitled “Modem Architecture for Joint Source Channel Decoding”; and

U.S. patent application Ser. No. ______ (Attorney Docket No. A05.01910001), filed on even date herewith and entitled “Modified Joint Source Channel Decoder.”

### BACKGROUND

1. Technical Field

The subject matter described herein relates to digital communication systems. More particularly, the subject matter described herein relates to the enhancement of speech quality when portions of a bit stream representing a speech signal are lost within the context of a digital communications system.

2. Description of Related Art

In speech coding (sometimes called “voice compression”), a coder encodes an input speech or audio signal into a digital bit stream for transmission or storage. A decoder decodes the bit stream into an output speech signal. The combination of the coder and the decoder is called a codec. The transmitted bit stream is usually partitioned into segments called frames, and in packet transmission networks, each transmitted packet may contain one or more frames of a compressed bit stream. In wireless or packet networks, sometimes the transmitted frames or packets are erased or lost. This condition is called frame erasure in wireless networks and packet loss in packet networks. When this condition occurs, to avoid substantial degradation in output speech quality, the decoder needs to perform frame erasure concealment (FEC) or packet loss concealment (PLC) to try to conceal the quality-degrading effects of the lost frames. Because the terms FEC and PLC generally refer to the same kind of technique, they can be used interchangeably. Thus, for the sake of convenience, the term “packet loss concealment”, or PLC, is used herein to refer to both.

In many digital communications systems, the bandwidth used by data applications far exceeds that used by voice calls. However, voice is still a major application and a main source of revenue and will be for years to come. It follows then that voice quality will remain very important as well. Packet loss rate (PLR) is the main contributing factor to voice quality. Packets may be lost for various reasons. In addition, packets that are not lost may be deemed to be lost if they are received with substantial bit errors. When packets are lost or deemed to be lost, various PLC techniques may be used to conceal their loss. Conventional PLC techniques typically rely on repetition, extrapolation, or interpolation of speech codec parameters and/or the speech signal to conceal a missing frame.

In a case in which a packet is actually received, but is deemed to be lost for any of a number of reasons, a channel decoding process may produce soft bit information pertaining to the bits of the packet. Such soft bit information represents a likelihood that each bit of the lost packet is a zero or a one. Certain PLC techniques have been developed that leverage such soft bit information to generate a replacement frame. See, for example, T. Fingscheidt, and P. Vary, “Softbit Speech Decoding: A New Approach to Error Concealment”, IEEE Transactions on Speech and Audio Processing, Vol. 9, No. 3, March 2001, pp. 240-251. Soft bit speech decoding takes advantage of the fact that most of the bits in a bad frame do not contain errors. There is a significant loss of information when the received bits in a bad frame are thrown away and PLC relies on repetition, extrapolation, or interpolation of speech codec parameters and/or the speech signal. However, for the bits that do contain errors, there is a risk that decoding the corresponding parameter will result in an audible, and sometimes unacceptable, artifact. On average, the speech quality may be improved, but if the worst case artifacts are unacceptable, the technique has limited or no practical value.

### BRIEF SUMMARY

Methods, systems, and apparatuses are described for performing packet loss concealment in a manner that utilizes bit information, such as but not limited to soft bit information produced by a channel decoding process, and that constrains one or more speech coding parameters, substantially as shown in and/or described herein in connection with at least one of the figures, as set forth more completely in the claims.

### BRIEF DESCRIPTION OF THE DRAWINGS/FIGURES

The accompanying drawings, which are incorporated herein and form a part of the specification, illustrate embodiments and, together with the description, further serve to explain the principles of the embodiments and to enable a person skilled in the pertinent art to make and use the embodiments.

FIG. 1 is a block diagram of a system for performing constrained soft decision packet loss concealment (CSD-PLC) according to an exemplary embodiment.

FIG. 2 depicts a flowchart of a method for performing CSD-PLC according to an exemplary embodiment.

FIGS. 3, 4 and 5 depicts respective flowcharts of methods for decoding an encoded parameter according to exemplary embodiments.

FIG. 6 depicts a step for determining if a decoded parameter violates a parameter constraint according to exemplary embodiments.

FIG. 7 depicts a step for determining if one or more of an encoded parameter and a decoded parameter, and/or a measure of change thereof, exceeds and/or is below one or more thresholds, according to example embodiments.

FIG. 8 depicts a step for determining each of one or more thresholds, according to example embodiments.

FIG. 9 depicts a flowchart of a method for generating an estimate of a decoded parameter, according to example embodiments.

FIG. 10 depicts a step for generating an estimate of a decoded parameter, according to example embodiments.

FIG. 11 is a block diagram of a computer system, according to example embodiments.

FIG. 12 shows a time waveform plot and corresponding spectrogram of a speech signal.

Embodiments will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### A. Introduction

The present specification discloses numerous example embodiments. The scope of the present patent application is not limited to the disclosed embodiments, but also encompasses combinations of the disclosed embodiments, as well as modifications to the disclosed embodiments.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the following sections, a new approach to packet loss concealment (PLC), which is sometimes referred to herein as “constrained soft decision PLC” or “CSD-PLC” is described. In accordance with certain embodiments, CSD-PLC combines soft bit decoding with parameter constraint.

In a typical PLC implementation, a bad frame indicator (BFI) signals that a frame of an encoded speech signal contains bit errors, in which case repetition, extrapolation, or interpolation of speech codec parameters and/or the speech signal is used to conceal the missing frame. In contrast, in a soft bit decoding approach, bit reliability (soft bit) information is exploited. For example, the speech decoder may be modified to use the soft bits in a manner that weights the reconstruction according to how reliable the corresponding bits are. In accordance with various embodiments, the soft bits may be derived from a channel decoding process, and can additionally incorporate a priori knowledge of the speech codec parameters.

Soft bit speech decoding takes advantage of the fact that most of the bits in a bad frame do not contain errors. There is a significant loss of information when a conventional PLC implementation throws away the received bits in a bad frame and instead relies on repetition, extrapolation, or interpolation of speech codec parameters and/or the speech signal to replace a missing frame. However, for the bits that do contain errors, there is a risk with soft bit decoding that decoding the corresponding parameter will result in an audible, and sometimes unacceptable, artifact. On average, the speech quality may be improved, but if the worst case artifacts are unacceptable, the technique has limited or no practical value.

In order to address this issue, the CSD-PLC technique described herein also employs what is referred to as parameter constraint. In accordance with parameter constraint, constraints on certain speech codec parameters are applied based on the natural evolution of such parameters. Such constraints may be obtained through offline training using a large speech database. Any parameter that falls outside of its constraints is assumed to contain errors and is replaced with an estimated value. A parameter constraint technique is described in commonly-owned U.S. Pat. No. 6,885,988 to Chen. In U.S. Pat. No. 6,885,988 to Chen, during encoding, a parameter of interest is made to conform to a constraint and therefore, at the decoder, if the parameter does not also conform, it is known that it is in error. The constraint is applied in all frames at the encoder, and hence, the constraint must be very conservative in order to include the vast majority of natural speech and avoid degrading the clean channel coded speech quality. However, since many encoders are standardized and cannot be modified, the technique is modified herein to only be applied at the decoder and only when frame error(s) are detected. As such, the constraints can be more aggressive in order to improve error detection and the approach is thus fundamentally different from that in U.S. Pat. No. 6,885,988 to Chen.

In further accordance with the CSD-PLC technique described herein, once the speech codec parameters have been obtained through the aforementioned soft bit decoding and parameter constraint processes, such parameters are then provided to a speech decoder that completes the decoding of the encoded frame to obtain the synthesized output speech.

Although the CSD-PLC technique described herein may be referred to as operating on frames of a signal, it is to be understood that such technique may also operate on sub-frames of a signal, or some other segments of a signal.

Furthermore, although the CSD-PLC technique described herein is described in reference to concealing one or more lost frames of an encoded speech signal, it is to be understood that the technique may be generally applied to any type of signal that can be transmitted, that includes some inherent redundancy, and that includes at least one parameter, regardless of whether such parameter(s) are included in the signal by a transmitter or encoder or derived from the signal by a receiver or decoder. Examples of signals to which the CSD-PLC technique may be applied include but are not limited to media or multimedia signals (such as signals that represent audio, images, video, or some combination thereof), seismic signals, remote-sensing signals (for example, signals that carry temperature, humidity, pressure, or other information acquired by one or more sensors), medical signals (for example, electroencephalograph (EEG), electrocardiograph (ECG) signals or the like), and the like.

In view of the foregoing, a method for performing packet loss concealment is described herein. In accordance with the method, in response to determining that an encoded frame that represents a segment of a signal is bad, a number of steps are performed. First, an encoded parameter within the encoded frame is decoded based on bit information associated with the encoded parameter to obtain a decoded parameter. Then, it is determined if the decoded parameter violates a parameter constraint. If it is determined that the decoded parameter does not violate the parameter constraint, then the decoded parameter is passed to a decoder for use in decoding the encoded frame. If it is determined that the decoded parameter does violate the parameter constraint, then an estimate of the decoded parameter is generated and passed to the decoder for use in decoding the encoded frame.

A system for performing packet loss concealment in response to a determination that an encoded frame representing a segment of a signal is bad is also described herein. The system includes bit decoding logic and parameter constraint logic. The bit decoding logic is configured to decode an encoded parameter within the encoded frame based on bit information associated with the encoded parameter to obtain a decoded parameter. The parameter constraint logic is configured to determine if the decoded parameter violates a parameter constraint. The parameter constraint logic is further configured to pass the decoded parameter to a decoder for use in decoding the encoded frame in response to determining that the decoded parameter does not violate the parameter constraint. The parameter constraint logic is also configured to generate an estimate of the decoded parameter and pass the estimate of the decoded parameter to the decoder for use in decoding the encoded frame in response to determining that the decoded parameter does violate the parameter constraint.

A computer program product comprising a computer-readable storage medium having computer program logic recorded thereon for enabling a processing unit to perform packet loss concealment in response to a determination that an encoded frame representing a segment of a signal is bad is also described herein. The computer program product includes first means and second means. The first means are for enabling the processing unit to decode an encoded parameter within the encoded frame based on bit information associated with the encoded parameter to obtain a decoded parameter. The second means are for enabling the processing unit to determine if the decoded parameter violates a parameter constraint and to pass the decoded parameter to a decoder for use in decoding the encoded frame in response to determining that the decoded parameter does not violate the parameter constraint. The second means are also for enabling the processing unit to generate an estimate of the decoded parameter and pass the estimate of the decoded parameter to the decoder for use in decoding the encoded frame in response to determining that the decoded parameter does violate the parameter constraint.

### B. Example Constrained Soft Decision Packet Loss Concealment System

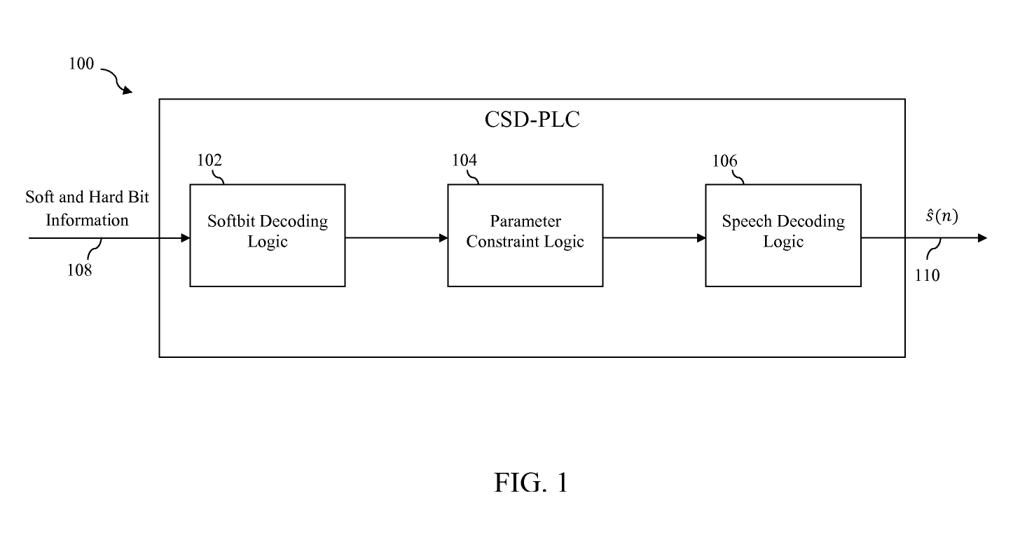

FIG. 1 is a block diagram of an example of a system for performing packet loss concealment according to an exemplary embodiment. In particular, FIG. 1 is a block diagram of an example Constrained Soft Decision Packet Loss Concealment (CSD-PLC) system, CSD-PLC system 100. As shown in FIG. 1, CSD-PLC system 100 includes soft bit decoding logic 102, parameter constraint logic 104, and speech decoding logic 106. Each of these components may be implemented in hardware, using analog and/or digital circuits, in software, through the execution of instructions by one or more general purpose or special-purpose processors, or as a combination of hardware and software. Details concerning the manner of operation each of these components will be provided below.

It is to be understood that the operations performed by CSD-PLC system 100 may be performed in response to a determination that an encoded frame that represents a segment of a speech signal and that has been received over a communication channel is bad. As used herein, the statement that the encoded frame is determined to be “bad” is meant to broadly encompass any determination that the encoded frame is not suitable for standard speech decoding. For example, the encoded frame may be determined to be bad if it contains bit errors. In further accordance with this example, a channel decoding process may operate to determine that the encoded frame contains bit errors and is thus bad. The encoded frame may be declared bad for other reasons as well.

As noted above, a channel decoder used in a channel decoding process may determine that the encoded frame is bad. For example, the encoded frame may have failed a cyclic redundancy check (CRC) or some other test for bit errors. In such a case, the encoded frame may be deemed bad by the channel decoder. However, even if an encoded frame is deemed bad, hard bit and soft bit information associated with bits of the encoded frame may be produced during the channel decoding process and passed to CSD-PLC system 100. For example, a conventional turbo decoder will produce both soft bit information (soft decisions or likelihoods concerning whether each bit of the encoded frame is a zero or a one) as well as hard bit information (hard decisions concerning whether each bit of the encoded frame is a zero or one) in association with each bit of the encoded frame. Such soft bit and hard bit information may be passed as an input to CSD-PLC system 100. This information is shown as soft bit and hard bit information 108 in FIG. 1.

Alternately, at least a portion of soft bit and hard bit information 108 may be obtained from a joint source channel decoding process such as that described in commonly-owned co-pending U.S. patent application Ser. No. ______ (Attorney Docket No. A05.01890001), entitled “Joint Source Channel Decoding Using Parameter Domain Correlation” and filed on even date herewith, the entirety of which is incorporated by reference as if fully set forth herein. As discussed in that application, the joint source channel decoding process may utilize a priori knowledge about the source speech signal to modify the soft bit information produced by a conventional channel decoder. Still other processes may be used to produce soft bit and hard bit information 108.

Generally speaking, CSD-PLC system 100 operates as follows. These operations may be performed in response to a determination that an encoded frame that represents a segment of a speech signal is bad.

First, soft bit decoding logic 102 utilizes soft bit and hard bit information 108 to decode one or more encoded parameters within the encoded frame to obtain one or more decoded parameters, respectively. The one or more encoded parameters may include, for example, one or more of gain, pitch, line spectral frequencies, pitch gain, fixed codebook gain, and fixed codebook excitation. The manner in which soft bit decoding logic operates to decode the one or more encoded parameters will be described in greater detail in Section B.1 below.

Parameter constraint logic 104 then operates to determine if each of the one or more decoded parameters violates a parameter constraint associated with that particular parameter. If a decoded parameter does not violate the parameter constraint associated therewith, then parameter constraint logic 104 will pass the decoded parameter to speech decoding logic 106. However, if a decoded parameter does violate the parameter constraint associated therewith, then parameter constraint logic 104 operates to generate an estimate of the decoded parameter which is then passed to speech decoding logic 106. The manner in which parameter constraint logic 104 operates to determine if each decoded parameter violates a corresponding parameter constraint and generates an estimate of each decoded parameter that is determined to violate a parameter constraint will be described in greater detail in Section B.2 below.

Speech decoding logic 106 utilizes the one or more decoded parameters, or estimates thereof, output by parameter constraint logic 104 to fully decode the encoded frame, thereby producing a corresponding segment of a decoded speech signal 110, also denoted ŝ(n).

B.1 Soft Bit Decoding Logic

Prior to describing the manner of operation of soft bit decoding logic 102, some background information regarding the nomenclature used in this section will first be provided. This nomenclature assumes that the soft bit information received by soft bit decoding logic 102 is provided by a joint source channel decoding process such as that described in commonly-owned co-pending U.S. patent application Ser. No. ______ (Attorney Docket No. A05.01890001), entitled “Joint Source Channel Decoding Using Parameter Domain Correlation” and filed on even date herewith, the entirety of which is incorporated by reference as if fully set forth herein. However, it is to be understood that the soft bit information received by soft bit decoding logic 102 may be provided by a conventional channel decoder, such as a conventional turbo decoder, or by some other process or component entirely.

First, let x₀={x₀(0), x₀(1)}, . . . , x₀(M−1)} be the M-bit coded representation of the parameter with x₀(m)ε{0,1}, m=0, 1, . . . , M−1. Hence, there are 2^{M} such vectors (also referred to herein as indices) with x₀ⁱ being the i^{th} vector. Let the complete received vector of indices for the preceding frame be denoted by Y₋₁. Let all bit locations except the m^{th} bit in x₀ be denoted by xx₀\m.

In the above-referenced U.S. patent application Ser. No. ______ (Attorney Docket No. A05.01890001), joint source channel decoding is applied to determine the conditional probability that the m^{th} bit in the encoded parameter is equal to x₀ (m) given that the received vector for the preceding frame is Ŷ₋₁ and given that the encoded parameter is x₀. Such probability may be represented as:

Pₚ(x₀(m)|Ŷ₋₁,x₀)

The probability information determined in this manner may comprise part of the soft bit information that is input to soft bit decoding logic 102.

In one embodiment, soft bit decoding logic 102 may utilize one of three different approaches to decode an encoded parameter. It is noted, however, that these three approaches are described by way of example only and are not intended to be limiting. Still other approaches may be used to decode an encoded parameter using hard and soft bit information.

In the first approach, an index is obtained for the encoded parameter by using the potentially error containing hard bits received from a channel decoding process. In other words, each bit of the index is assigned a hard bit value (i.e., “0” or “1”) obtained from the channel decoding process. The index so obtained is then used to decode the encoded parameter, thereby producing a decoded parameter.

In the second approach, a maximum a posteriori probability (MAP) estimator is used. Such MAP estimator selects one of the set of 2^{M} possible indices for the encoded parameter based on the soft bit information, wherein the index that is selected has the maximum probability. In particular, the MAP estimator selects the one of the 2^{M} possible indices, v, that yields the maximum total probability:

v=arg maxᵢ P(x₀⁽ⁱ⁾|Ŷ₋₁,x₀)

In other words, for each index in the set of 2^{M} possible indices, the probabilities associated with each bit in the index are multiplied together to produce a total probability for the index. The index having the maximum total probability value is the index that is selected, v. The selected index v is then used to decode the encoded parameter, thereby producing a decoded parameter u_{MAP} that minimizes the decoding error probability. This can be represented as:

U_{MAP}==u^{v}

wherein u^{v} is the decoded parameter obtained using index v.

In the third approach, a minimum mean square (MS) estimator is used. Such MS estimator weights each of the decoded parameters obtained using each of the 2 M possible indices by the corresponding index probability and then sums the weighted decoded parameters together to obtain a combined decoded parameter:

$${u}_{MS} = {\sum }_{i = 0}^{{2}^{M} - 1} {u}^{( i )} \cdot P ( {\underline{x}}_{0}^{( i )} \vert {\underline{\hat{Y}}}_{- 1} , {\underline{x}}_{0} )$$

The combined decoded parameter u_{MS} is thus the output of the MS estimator.

For the MS estimator, the complexity may be non-trivial for large M. Often, the bulk of the likelihood is contained in a small number of indices having bits that correspond to the most likely bit values. In view of this, a modified approach may be used that uses only the most likely indices x₀⁽ⁱ⁾, limiting the number used when the cumulative probability exceeds a certain threshold. If \hat{x}₀⁽ⁱ⁾ is x₀⁽ⁱ⁾ reordered such that

P(\hat{x}₀⁽ⁱ⁾|Ŷ₋₁,x₀)≧P(\hat{x}₀⁽ⁱ⁺¹⁾|Ŷ₋₁,x₀)

and N is such that

$${\sum }_{i = 0}^{N - 2} P ( {\underline{\hat{x}}}_{0}^{( i )} \vert {\underline{\hat{Y}}}_{- 1} , {\underline{x}}_{0} ) < {T}_{PROB} \leq {\sum }_{i = 0}^{N - 1} P ( {\underline{\hat{x}}}_{0}^{( i )} \vert {\underline{\hat{Y}}}_{- 1} , {\underline{x}}_{0} )$$

where T_{PROB} is a predefined probability threshold, then

$${u}_{MS} = \frac{{\sum }_{i = 0}^{N - 1} {u}^{( i )} \cdot P ( {\underline{\hat{x}}}_{0}^{( i )} \vert {\underline{\hat{Y}}}_{- 1} , {\underline{x}}_{0} )}{{\sum }_{i = 0}^{N - 1} P ( {\underline{\hat{x}}}_{0}^{( i )} \vert {\underline{\hat{Y}}}_{- 1} , {\underline{x}}_{0} )}$$

N may also be limited such that

N≦Nₘₐₓ

In certain embodiments, the codec used for encoding and decoding the parameters is the Adaptive Multi-Rate (AMR or AMR-NB) audio codec operating at 12.2 Kb/s (also referred to as AMR-NB 12.2). Speech coding parameters used in AMR-NB 12.2 include pitch, line spectral frequencies (LSFs), pitch gain, fixed codebook gain, and fixed codebook excitation. A parameter decoding method that may be applied for each of these parameters in AMR-NB 12.2 will now be described. It is noted, however, that the parameter decoding methods described below are provided herein by way of example only and are not intended to be limiting.

Pitch.

In the 1st and 3rd sub-frames, the pitch is quantized using a 9-bit scalar quantizer. Soft bit decoding logic 102 may use the MAP estimator described above to decode the pitch in these sub-frames. In the 2nd and 4th sub-frames, the difference between the current and prior sub-frame is quantized. In these sub-frames, soft bit decoding logic 102 may use a built-in concealment approach associated with AMR-NB, which simply substitutes the previous pitch for the current pitch.

Line Spectral Frequencies (LSFs).

Soft bit decoding logic 102 may use the aforementioned modified MS estimator, û_{MS}, to obtain an estimate of the quantized prediction residual vector. Reconstruction of the LSFs may then follow the standard approach disclosed in 3GPP TS 26.090: “Mandatory Speech Codec speech processing function; Adaptive Multi-Rate (AMR) speech codec; Source controlled rate operation” by adding the prediction residual to the prediction vector.

Pitch Gain.

In AMR-NB 12.2, the pitch gain is scalar quantized every sub-frame using 4 bits. Soft bit decoding logic 102 may use the aforementioned modified MS estimator, û_{MS}, to decode the pitch gain.

Fixed Codebook Gain.

In AMR-NB 12.2, the prediction residual after 4-th order moving average (MA) prediction is scalar quantized with 5 bits. Soft bit decoding logic 102 may use aforementioned modified MS estimator, û_{MS}, to estimate the prediction residual. Reconstruction of the fixed codebook gain then follows the standard reconstruction method by adding the prediction component.

Fixed Codebook Excitation.

The fixed codebook excitation may be generated according to the standard method described in “3GPP TS 26.091 version 9.0.0 Release 9, “Mandatory Speech Codec speech processing function; Adaptive Multi-Rate (AMR) speech codec; Error concealment of lost frames.”

B.2. Parameter Constraint Logic

Prior to describing the manner of operation of parameter constraint logic 104, some background information regarding the evolution of a speech signal over time and the correlation of speech coding parameters is now provided.

Speech is produced by the human vocal system which in simple terms includes the lungs, trachea bronchi, vocal cords, vocal tract, nasal tract, mouth, nostrils and lips. Speech is then the acoustic wave that is emitted from this system when air is expelled from the lungs, passing through the vocal tract and potentially the nasal tract before exiting at the lips. Constrictions along the way perturb the airflow and give it the desired sound to convey a message.

Speech sounds can be broadly classified into three categories: (1) voiced speech, which is produced by forcing air past the vocal cords which oscillate to produce a near periodic pulse train of air that excites the vocal tract; (2) unvoiced speech, which is produced by creating a constriction in the vocal tract that produces a turbulent airflow that when passed through the vocal tract produces a broad spectrum speech signal that takes the appearance of a noise-like waveform; and (3) plosive speech, which is generated by building up air pressure behind a closure in the vocal tract (for example, the lips) and then suddenly releasing it, producing a burst of noise-like waveform.

As the air passes through the vocal tract, the frequency spectrum is shaped by the filtering characteristics of the tract, depending upon its shape and dimensions at the time. Different sounds are produced by varying the vocal tract over time. The vocal tract will contain resonance frequencies or formant frequencies that subsequently vary over time.

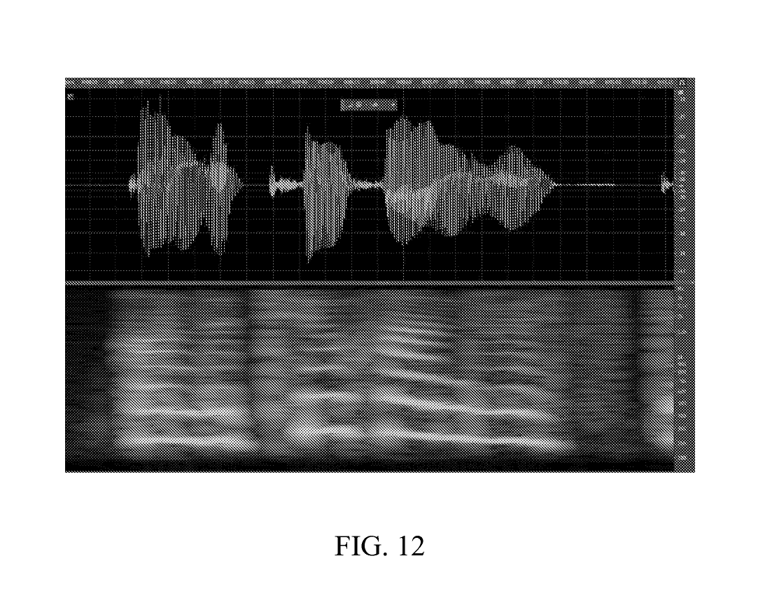

These concepts are demonstrated in the time waveform plot and corresponding spectrogram of a speech signal shown in FIG. 12. In the time domain, voiced speech can be identified as generally high amplitude quasi-periodic segments, while unvoiced regions are seen as lower amplitude noise-like segments. A sudden noise-like burst preceded by silence is also evident in the plot and is identified as a plosive sound. In the spectrogram, the voiced regions have a striated appearance due to the periodicity of the waveform. The brightest bands correspond to the highest energy frequencies and can be used to identify the formants, which are most prominent during voiced speech. In contrast, unvoiced speech is characterized by a more solid or evenly distributed energy profile across frequencies.

The physical limitations of the speech production process places limits on how quickly various aspects of the speech signal can change over time. In addition, most languages can be described in terms of distinctive sounds, or phonemes that, generally speaking, have an average duration on the order of 100 ms. Considering that the frame size of AMR is 20 ms, it is then straightforward to reason that the speech waveform (or alternatively, the coded speech codec parameters) in one speech frame will generally be correlated with neighboring frames, both in the past and future. For example, the pitch during voiced speech changes slowly from one period to the next. The total frame energy also evolves slowly during voiced speech. The formants seen in the spectrogram of FIG. 12 are highly correlated over time, as evidenced by their banding appearance.

The speech production process is highly coupled. That is, the modification of one aspect often affects or is related to the changing of other aspects. This is due to the physical connection of the various parts of the vocal system, and also because of the nature of spoken language. As such, different speech codec parameters are often related or correlated with one another both across frames and within the same frame. For example, because voiced speech is often characterized by slowly varying pitch, energy, and formant structure, the observation that the pitch and energy change very little from the last frame suggests that the formant structure also probably changed very little. In contrast, if the frame boundaries happen to straddle the transition from an unvoiced region to a voiced region, the abrupt change in energy is an indication the pitch and spectral content may vary significantly from the past.

Considering the above discussion, it can be said that the natural evolution of speech (and hence, the underlying speech codec parameters) over time is constrained by the physical limitations of the human speech production process and by the nature of spoken language. The evolution is well predicted by the neighboring past and future speech frames. These facts can be exploited in the detection of bit-errors. Bit-errors in a parameter may result in a decoded value that is highly unlikely, given the natural constraints placed on the parameter evolution. By knowing what is highly unlikely and setting a threshold, the parameter can be declared corrupted if it exceeds this threshold.

Conditional probability can be used to determine the threshold for what is highly unlikely. Consider events F and G in some probability space. Conditional probability, denoted P(F|G), is defined as the probability that event F occurs given the prior knowledge that event G has occurred. This can be expanded to be conditional on multiple events. P(F|G₁, G₂, . . . , G_{N}) is the probability that event F occurs given the prior knowledge that events G₁, G₂, . . . , G_{N} have occurred.

In the case of a codec, the events may be derived from the quantized codec parameters received at the decoder. Let the quantized bit-stream containing K indices for frame n be denoted: Aₙ={a₁, a₂, . . . a_{K}}. Previous and future frames may be used in the conditional probability, so let A=A_{-N1 . . . N2}={A_{-N1}, A_{-N1+1}, . . . , Aₙ, . . . , A_{N2-1}, A_{N2}}. The events in the conditional probability may be the index value equal to some value, aₖ=Vₖ. Alternatively, if Pₖ={p₁, p₂, . . . , p_{M}}=Q⁻¹(aₖ) is the decoded parameter(s) (note that Pₖ can be a scalar or vector depending on the quantization method), the conditional probability may be that the decoded parameter(s) are within some interval

Tₚ_{ᵢ}^{low}≦pᵢ<Tₚ_{ᵢ}^{hi} iε{1,2, . . . ,M},

where Tₚ_{ᵢ}^{low} and Tₚ_{ᵢ}^{hi} represent predefined low and high thresholds, respectively.

Even more generally, one can define N+1 different functions ƒᵢ(A) i=0 . . . N based on the received index set. One can then define N discrete random variables Xᵢ i=1 . . . N where

P(Xᵢ=j)=P(Tᵢ^{j}≦ƒᵢ(A)<Tᵢ^{j+1}) i=1 . . . N, jε{1,2, . . . ,Jᵢ}

The discrete random variable X₀ is defined as

P(X₀=j)=P(T₀^{j}≦ƒ₀(A)<T₀^{j+1}) jε{1,2}

The thresholds are determined such that one outcome, say j=1, is highly likely given the natural evolution of ƒ₀(A), while the other outcome, j=2 in this case, is highly unlikely in natural speech and is hence likely due to bit-errors. The thresholds can be made dependent upon the value of each dependent random variable, Xᵢ. Hence, the thresholds will be in an N dimensional space with dimension J₁×J₂× . . . ×J_{N}. One can define T₀^{j}(j₁, j₂, . . . J_{N}) to be the j^{th} threshold when X₁=j₁, X₂=J₂, . . . , X_{N}=j_{N}. Then

$$\begin{matrix}P ( {X}_{0} = j \vert {X}_{0} = {j}_{0} , {X}_{1} = {j}_{1} , … , {X}_{N} = {j}_{N} ) \\ = P ( {T}_{0}^{j} ( {j}_{1} , {j}_{2} , … , {j}_{N} ) \leq {f}_{0} ( A ) < {T}_{0}^{j + 1} ( {j}_{1} , {j}_{2} , … , {j}_{N} ) )\end{matrix}$$

$$j ∈ \{ 1 , 2 \} , {j}_{i} ∈ \{ 1 , 2 , … , {j}_{i} \}$$

The thresholds may be obtained from conditional probability density functions (PDFs) determined by observation over a large speech database. That is, for each possible combination of (X₁, X₂, . . . , X_{N}), a PDF may be obtained. The probability corresponding to “highly likely” is dependent upon such factors as the bit-error sensitivity of ƒ₀(A) versus the speech quality degradation that occurs when a bit-error condition is falsely declared. For example, the probability used may fall in the range of 0.90-0.999.

It can be seen from the foregoing that, depending upon how function ƒ₀(A) is defined, the determination of whether such function falls in the “highly likely” or “highly unlikely” region may be carried out in the index domain and/or in the decoded parameter domain. Furthermore, the function may take into consideration the degree of change of one parameter with respect to the degree of change of any number of other parameters, and may include or not include the parameter for which the change is being tested. Additionally, the function may take into consideration parameter changes in any past, present, or future frame of the speech signal.

If ƒ₀(A) is found to fall in the “highly unlikely” region, the bits used by ƒ₀(A) in Aₙ are declared to contain bit-errors. Some form of bit-error concealment must then be performed. This may be done in multiple ways.

In accordance with one approach, the soft-bits of Aₙ are examined to try and determine which bit(s) may be in error. For example, if one soft bit has nearly equal chances of 0 or 1, while all other soft bits are highly polarized, the bit in question may be flipped. The above constraint test is then re-applied to determine if the test now falls in the “highly likely” region.

In accordance with another approach, it is determined which decoded codec parameters are in error given that bit-error(s) were declared in Aₙ. Once the parameters are identified, standard parameter based concealment methods can be applied, such as prediction, interpolation, extrapolation, repetition, or the like.

Still other methods may be used to generate an estimate of the decoded parameter if the parameter constraint test returns a “highly unlikely” result.

A specific example of the operation of parameter constraint logic 102 will now be provided. In particular, a specific example in which the parameter of interest is gain will be provided. In many speech codecs, the gain of a particular frame or sub-frame is quantized in the log domain. Consider, for example, a speech codec with a 20 ms frame whose gain is scalar quantized in the log domain on a 5 ms basis. Define

lg_{sf}(n) sfε{1,2,3,4}

to be the log-gain in sub-frame sf of frame n. The log-gain for each sub-frame is decoded by

lg_{sf}(n)=Q_{lg}_{_{sf}}⁻¹(Aₙ).

In this example, whether a parameter constraint has been violated will be determined in the domain of the decoded sub-frame log-gain, so function ƒ₀(A) is defined as follows:

ƒ₀(A)=Q_{lg}_{_{sf}}⁻¹(Aₙ).

For simplicity of subscripts, consider sf=1. Because the last sub-frame log-gain is strongly correlated with the current sub-frame, a function ƒ₁(A) is defined as follows:

ƒ₁(A)=Q_{lg}_{₄}⁻¹(Aₙ₋₁)

Furthermore, the prior change in log-gain from one sub-frame to the next is strongly correlated with the change in the current log-gain from the last. Accordingly, a function ƒ₂(A) is defined as follows:

ƒ₂(A)=lg₄(n−1)−lg₃(n−1).

The three discrete random variables X₀, X₁, X₂ then follow from the above definitions. Reasonable values for J₁ and J₂ are on the order of 10-30 depending on the desired performance/table-size trade-off. Because the gain is in the log-domain, uniformly spaced thresholds suffice for X₁, X₂.

For bit-errors in the gain, errors that result in a significant increase in the gain are of greatest concern. In this case, T₀¹(·)=−∞, T₀³(·)=∞, and hence, only T₀²(∞) needs to be determined and stored in a table. Therefore, the number of thresholds required to be stored is J₁×J₂.

It is noted that if the average speech log-gain changes over time (for example, from one call to the next due to different phones), the long-term log-gain can be removed from the dequantized value in ƒ₁(A).

Persons skilled in the relevant art(s) will readily appreciate that the above example can be easily modified for application to the subsequent sub-frames 2, 3, and 4.

If an error is detected in the sub-frame gain, it must be concealed. One concealment approach that may be used is to generate an estimate of the sub-frame gain by using a modified version of the prior gain that is decayed towards a zero linear gain over time. If the gain is in the log domain, this corresponds to subtracting by a delta each time.

### C. Example Constrained Soft Decision Packet Loss Concealment Methods

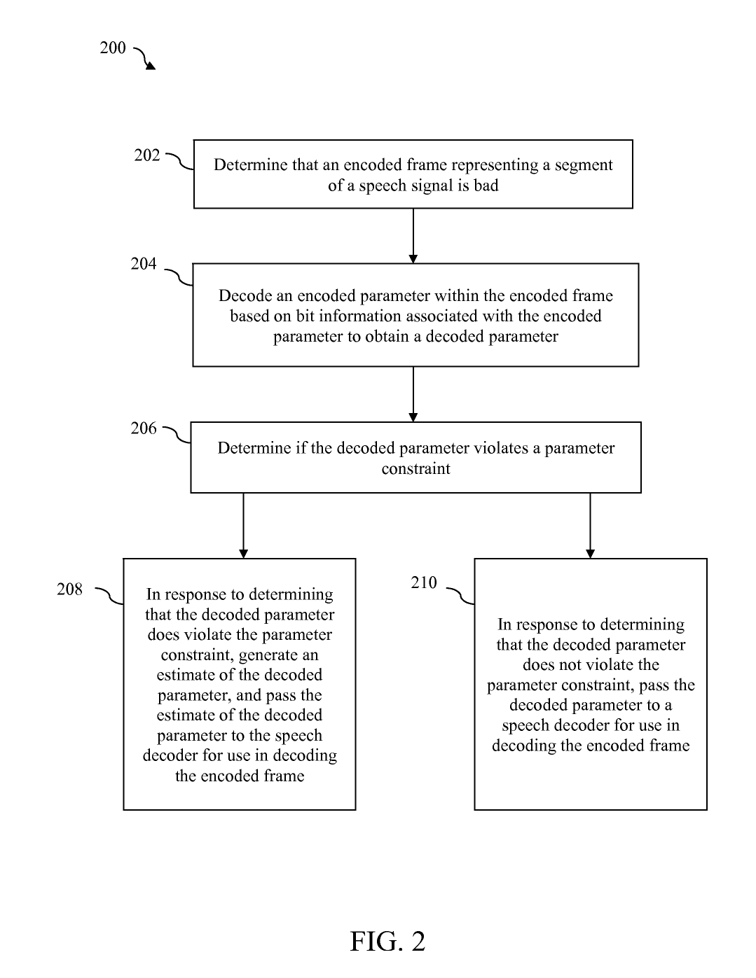

FIG. 2 depicts a flowchart 200 of method for performing CSD-PLC according to an example embodiment. As shown in FIG. 2, the method of flowchart 200 begins with step 202. In step 202, a determination is made that an encoded frame representing a portion of a speech signal is bad. For example, as explained above, a determination may be made based on the result of a CRC during a channel decoding process that a frame is bad.

In response to a determination that the encoded frame is bad, in step 204, an encoded parameter within the encoded frame is decoded based on bit information associated with the encoded parameter to obtain a decoded parameter. For example, soft bit decoding logic 102 of FIG. 1 may decode the encoded parameter using soft bit and hard bit information 108. The bit information may be obtained at least in part from the channel decoding process.

In step 206, a determination is made as to whether or not the decoded parameter obtained during step 204 violates a parameter constraint. For example, parameter constraint logic 104 of FIG. 1 may determine whether or not the decoded parameter violates a parameter constraint. As explained above in Section B.2, this may be accomplished by determining if one or more of the encoded parameter and the decoded parameter, and/or a measure of change thereof, exceeds and/or is below one or more thresholds.

If it is determined in step 206 that the decoded parameter does not violate the parameter constraint, flow continues to step 208. In step 208, in response to determining that the decoded parameter does not violate the parameter constraint, the decoded parameter is passed to a speech decoder for use in decoding the encoded frame. For example, the decoded parameter may be passed to speech decoding logic 106 of FIG. 1 for use in decoding the encoded frame.

If it is determined in step 206 that the decoded parameter does violate the parameter constraint, flow continues to step 210. In step 210, in response to determining that the decoded parameter does violate the parameter constraint, an estimate of the decoded parameter is generated, and the estimate of the decoded parameter is passed to the speech decoder for use in decoding the encoded frame. For example, the estimate of the decoded parameter may be passed to speech decoding logic 106 of FIG. 1 for use in decoding the encoded frame.

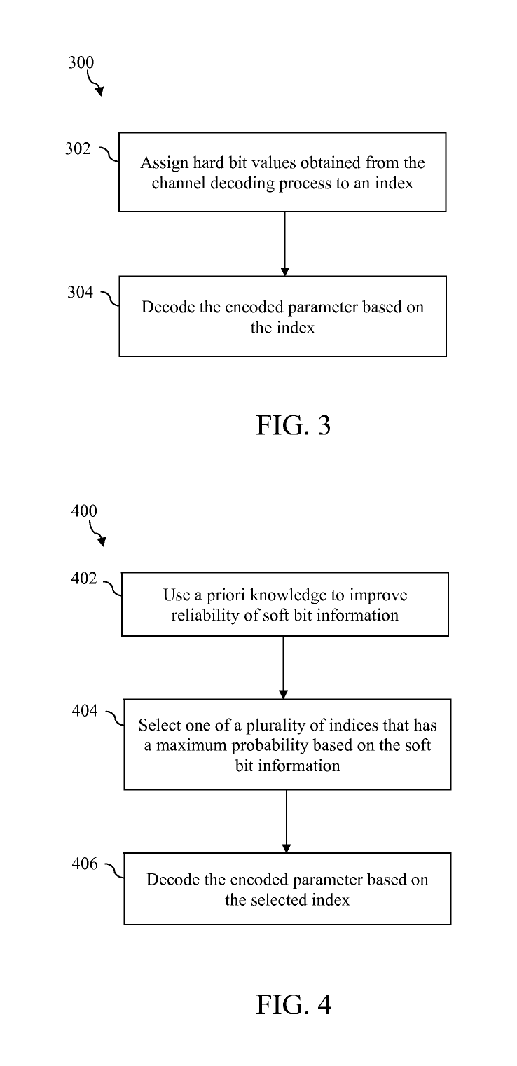

FIGS. 3, 4 and 5 depict flowcharts 300, 400 and 500, respectively, of methods for performing step 204 of flowchart 200. Each of these methods may be performed, for example, by soft bit decoding logic 102 of FIG. 1.

As shown in FIG. 3, the method of flowchart 300 begins with step 302. In step 302, hard bit values obtained from a channel decoding process are assigned to an index. For example, soft bit decoding logic 102 of FIG. 1 may assign hard bit values from soft bit and hard bit information 108 to the index. In step 304, the encoded parameter is decoded based on the index obtained during step 302.

As shown in FIG. 4, the method of flowchart 400 of FIG. 4 begins with step 402. In step 402, a priori knowledge is used to improve the reliability of soft bit information, such as soft bit information produced by a channel decoding process. For example, a joint source channel decoding process such as that described in commonly-owned co-pending U.S. patent application Ser. No. ______ (Attorney Docket No. A05.01890001), entitled “Joint Source Channel Decoding Using Parameter Domain Correlation” and filed on even date herewith, the entirety of which is incorporated by reference as if fully set forth herein, may use a priori knowledge about a source speech signal to modify the soft bit information produced by a conventional channel decoder to improve the reliability thereof. Still other methods may be applied that utilize a priori knowledge to improve the reliability of soft bit information, such as soft bit information produced by a channel decoding process.

In step 404, one of a plurality of indices that has a maximum probability is selected based on the soft bit information. For example, as explained above in Section B.1, a maximum a posteriori probability (MAP) estimator may select the one index among a set of 2^{M} possible indices that has a maximum probability, wherein the probability for each index is obtained by multiplying the individual bit probabilities together for that index.

In step 406, the encoded parameter is then decoded based on the index that was selected during step 404. The decoded parameter so obtained is the decoded parameter that minimizes the decoding error probability.

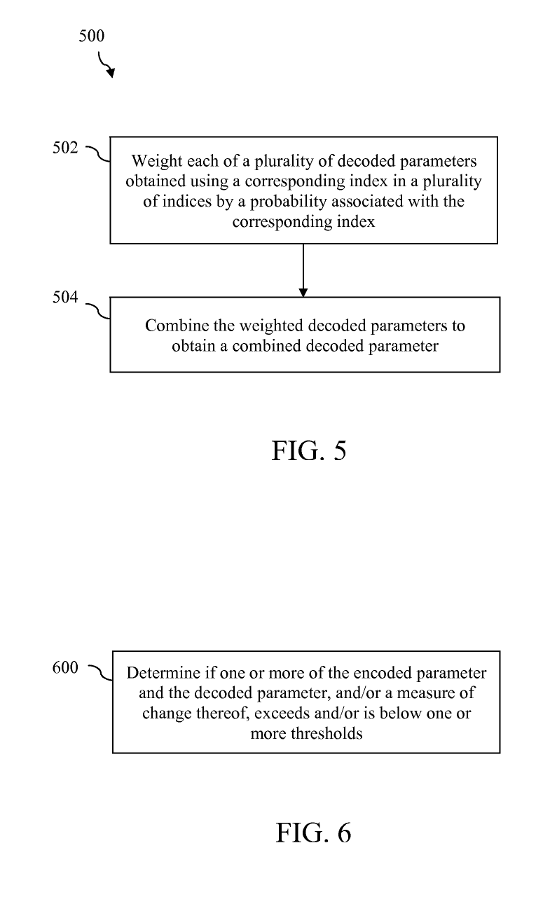

As shown in FIG. 5, the method of flowchart 500 begins with step 502. In step 502, each of a plurality of decoded parameters obtained using a corresponding index in a plurality of indices is weighted by a probability associated with the corresponding index. The probability associated with each index is obtained based on the soft bit information. In step 504, the weighted decoded parameters obtained during step 502 are combined to obtain a combined decoded parameter. As explained above in Section B.1, in one embodiment, a minimum mean square (MS) estimator may be used to obtain the combined decoded parameter.

In one embodiment, the plurality of indices for which weighted decoded parameters are obtained may include all possible index values for the parameter. Alternatively, as discussed above in Section B.1, a reduced number of indices may be used. For example, the plurality of indices may include a selected subset of all possible indices for the parameter. Such subset may be selected by arranging each of the indices in a sequence from most likely to least likely based on the soft bit information and selecting up to a certain number of indices in the sequence starting with the first index in the sequence. The number of indices selected may be determined by accumulating the probabilities associated with each selected index and comparing the total to a probability threshold. The number of indices selected may also be limited to a predefined number. In this manner, only the most likely indices are used for decoding.

FIG. 6 depicts a step 600 for determining if a decoded parameter violates a parameter constraint, according to example embodiments. For example, parameter constraint logic 104 of FIG. 1 may determine if the decoded parameter obtained during step 204 violates a parameter constraint in accordance with step 600.

As shown in FIG. 6, in step 600, it is determined whether one or more of the encoded parameter and the decoded parameter, and/or a measure of change thereof, exceeds and/or is below one or more thresholds. For example, as explained above in section C, a test for a parameter constraint violation may be performed in the index domain, i.e., when the parameter is encoded, in the parameter domain, i.e., when the parameter is decoded, or a combination thereof, e.g., in a function that transforms the parameter from the index domain to the parameter domain. For example, parameter constraint logic 104 of FIG. 1 may determine whether one or more of the encoded parameter and the decoded parameter obtained during step 204, and/or a measure of change thereof, exceeds and/or is below one or more thresholds.

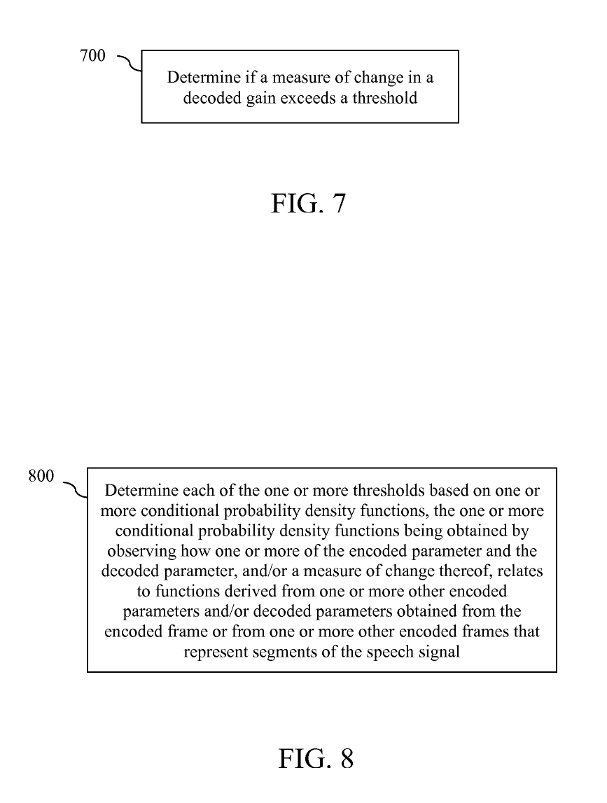

FIG. 7 depicts a step 700 for determining if one or more of the encoded parameter and the decoded parameter, and/or a measure of change thereof, exceeds and/or is below one or more thresholds, according to example embodiments. Parameter constraint logic 104 of FIG. 1 may perform step 700.

As shown in FIG. 7, in step 700, it is determined whether a measure of change in a decoded gain exceeds a threshold. For example, parameter constraint logic 104 of FIG. 1 may determine if a measure of change in a decoded gain exceeds a threshold. As described in Section B.2 above, the thresholds may be determined from a probability density function (PDF) and stored in a table. Then, a measure of change of the gain from one frame or sub-frame to the next may be compared to the threshold. The threshold may be a value above which a measure of change is considered highly unlikely. Alternatively, the threshold may include two values, with a range delineated by the two threshold values indicating a measure of change that is considered highly likely, or highly unlikely. In some cases, the threshold may be a value below which a measure of change is deemed highly likely, or highly unlikely.

FIG. 8 depicts a step 800 for determining each of the one or more thresholds, according to example embodiments. Parameter constraint logic 104 of FIG. 1 may perform step 800.

As shown in FIG. 8, in step 800, each of the one or more thresholds is determined based on one or more conditional probability density functions. In some embodiments, parameter constraint logic 104 of FIG. 1 determines each of the one or more thresholds based on one or more conditional probability density functions. As described above in section B.2, the one or more conditional probability density functions may be obtained by observing how one or more of the encoded parameter and the decoded parameter, and/or a measure of change thereof, relates to functions derived from one or more other encoded parameters and/or decoded parameters obtained from the encoded frame or from one or more other encoded frames that represent segments of the speech signal. Thus, a probability of a parameter under observation having a particular value or changing by a particular amount may be conditioned upon a probability associated with one or more functions, wherein each function may be based on any number of other parameters in any frame of the speech signal occurring before or after a current frame, and/or within the current frame.

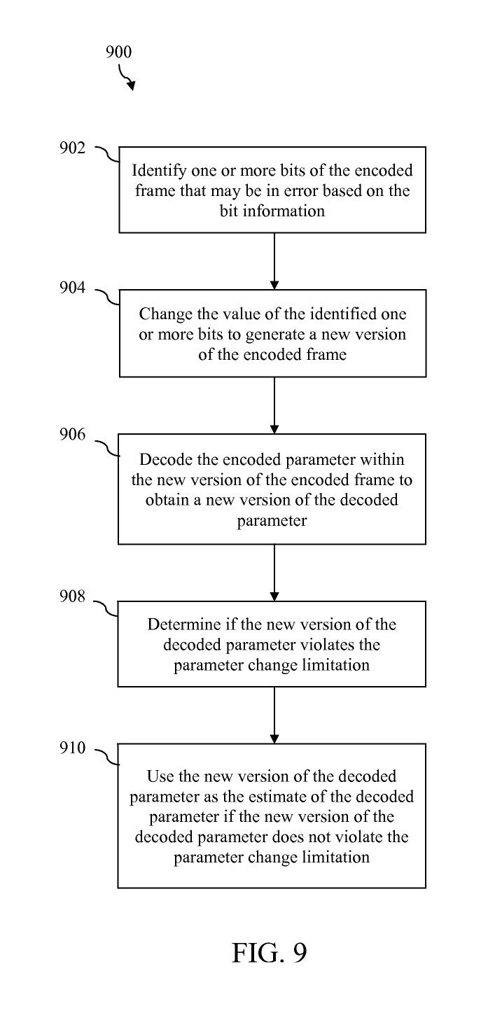

FIG. 9 depicts a flowchart 900 of an example method for generating the estimate of the decoded parameter in step 208, according to example embodiments. Parameter constraint logic 104 of FIG. 1 may perform the steps of flowchart 900.

As shown in FIG. 9, the method of flowchart 900 begins with step 902. In step 902, one or more bits of the encoded frame that may be in error are determined based on the bit information. For example, as described above is section B.2, if the bit information for a particular bit indicates a 50% probability that the bit is a either a “0” or a “1”, and the remaining bit probabilities are more certain, the particular bit may be in error. In step 904, the value of the identified one or more bits is changed to generate a new version of the encoded frame. Thus, in our example, the value of the particular bit identified as possibly being in error may be flipped back to its, presumably, original state, thereby generating a new version of the encoded frame. In step 906, the encoded parameter within the new version of the encoded frame is decoded to obtain a new version of the decoded parameter. For example, the new version of the encoded parameter may be decoded in accordance with any of the decoding methods described in section B.1. In step 908, whether the new version of the decoded parameter violates the parameter constraint is determined. In step 910, the new version of the decoded parameter is used as the estimate of the decoded parameter if the new version of the decoded parameter does not violate the parameter constraint.

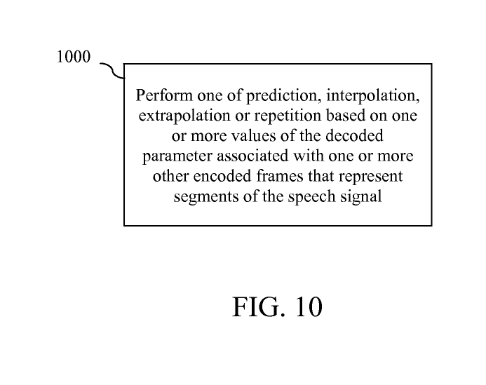

FIG. 10 depicts a step 1000 for generating the estimate of the decoded parameter in step 208, according to further example embodiments. Parameter constraint logic 104 of FIG. 1 may perform step 1000.

As shown in FIG. 10, in step 1000, the estimate of the decoded parameter is generated by performing one of prediction, interpolation, extrapolation or repetition based on one or more values of the decoded parameter associated with one or more other encoded frames that represent segments of the speech signal.

### D. Example Computer System Implementations

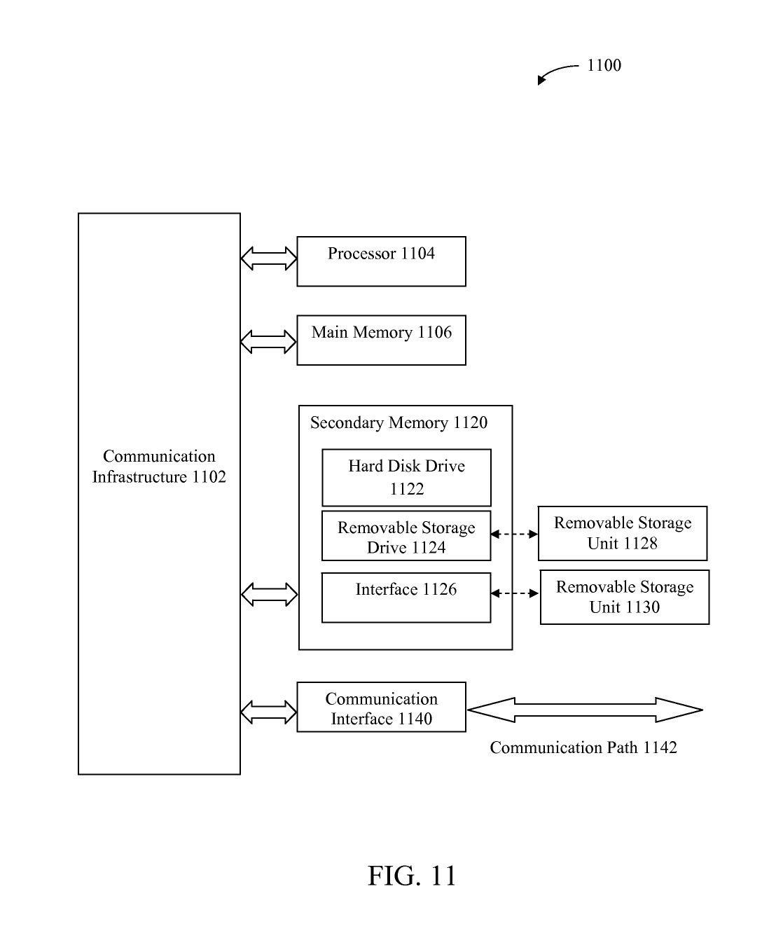

The following description of a general purpose computer system is provided for the sake of completeness. The present invention can be implemented in hardware, or as a combination of software and hardware. Consequently, the invention may be implemented in the environment of a computer system or other processing system. An example of such a computer system 1100 is shown in FIG. 11.

Computer system 1100 includes one or more processors, such as processor 1104. Processor 1104 can be a special purpose or a general purpose digital signal processor. Processor 1104 is connected to a communication infrastructure 1102 (for example, a bus or network). Various software implementations are described in terms of this exemplary computer system. After reading this description, it will become apparent to a person skilled in the relevant art(s) how to implement the invention using other computer systems and/or computer architectures.

Computer system 1100 also includes a main memory 1106, preferably random access memory (RAM), and may also include a secondary memory 1120. Secondary memory 1120 may include, for example, a hard disk drive 1122 and/or a removable storage drive 1124, representing a floppy disk drive, a magnetic tape drive, an optical disk drive, or the like. Removable storage drive 1124 reads from and/or writes to a removable storage unit 1128 in a well known manner. Removable storage unit 1128 represents a floppy disk, magnetic tape, optical disk, or the like, which is read by and written to by removable storage drive 1124. As will be appreciated by persons skilled in the relevant art(s), removable storage unit 1128 includes a computer usable storage medium having stored therein computer software and/or data.

In alternative implementations, secondary memory 1120 may include other similar means for allowing computer programs or other instructions to be loaded into computer system 1100. Such means may include, for example, a removable storage unit 1130 and an interface 1126. Examples of such means may include a program cartridge and cartridge interface (such as that found in video game devices), a removable memory chip (such as an EPROM, or PROM) and associated socket, and other removable storage units 1130 and interfaces 1126 which allow software and data to be transferred from removable storage unit 1130 to computer system 1100.

Computer system 1100 may also include a communications interface 1140. Communications interface 1140 allows software and data to be transferred between computer system 1100 and external devices. Examples of communications interface 1140 may include a modem, a network interface (such as an Ethernet card), a communications port, a PCMCIA slot and card, etc. Software and data transferred via communications interface 1140 are in the form of signals which may be electronic, electromagnetic, optical, or other signals capable of being received by communications interface 1140. These signals are provided to communications interface 1140 via a communications path 1142. Communications path 1142 carries signals and may be implemented using wire or cable, fiber optics, a phone line, a cellular phone link, an RF link and other communications channels.

As used herein, the term “computer-readable storage medium” is used to generally refer to tangible storage media and devices such as removable storage units 1128 and 1130 or a hard disk installed in hard disk drive 1122. These computer program products are means for providing software to computer system 1100.

Computer programs (also called computer control logic) are stored in main memory 1106 and/or secondary memory 1120. Computer programs may also be received via communications interface 1140. Such computer programs, when executed, enable the computer system 1100 to implement the present invention as discussed herein. In particular, the computer programs, when executed, enable processor 1100 to implement the processes of the present invention, such as any of the methods shown in FIGS. 2-10, and any other methods described herein. Accordingly, such computer programs represent controllers of the computer system 1100. Where embodiments are 3 implemented using software, the software may be stored in a computer program product and loaded into computer system 1100 using removable storage drive 1124, interface 1126, or communications interface 1140.

In another embodiment, features of the invention are implemented primarily in hardware using, for example, hardware components such as application-specific integrated circuits (ASICs) and gate arrays. Implementation of a hardware state machine so as to perform the functions described herein will also be apparent to persons skilled in the relevant art(s).

### E. Conclusion

While various embodiments have been described above, it should be understood that they have been presented by way of example only, and not limitation. It will be apparent to persons skilled in the relevant art that various changes in form and detail can be made therein without departing from the spirit and scope of the embodiments. Thus, the breadth and scope of the embodiments should not be limited by any of the above-described exemplary embodiments, but should be defined only in accordance with the following claims and their equivalents.

What is claimed is:

1. A method for performing packet loss concealment, comprising:
determining that an encoded frame is bad, the encoded frame representing a segment of a signal;
in response to determining that the encoded frame is bad:
decoding an encoded parameter within the encoded frame based on bit information associated with the encoded parameter to obtain a decoded parameter;
determining if the decoded parameter violates a parameter constraint;
in response to determining that the decoded parameter does not violate the parameter constraint, passing the decoded parameter to a decoder for use in decoding the encoded frame; and
in response to determining that the decoded parameter does violate the parameter constraint, generating an estimate of the decoded parameter, and passing the estimate of the decoded parameter to the decoder for use in decoding the encoded frame.

2. The method of claim 1, wherein the encoded parameter comprises one of: gain, pitch, line spectral frequencies, pitch gain, fixed codebook gain, and fixed codebook excitation.

3. The method of claim 1, wherein the bit information comprises soft bit information obtained from a channel decoding process.

4. The method of claim 1, wherein decoding the encoded parameter based on the bit information comprises:
assigning hard bit values obtained from the channel decoding process to an index; and
decoding the encoded parameter based on the index.

5. The method of claim 1, wherein the bit information comprises soft bit information, and wherein decoding the encoded parameter based on the bit information comprises:
using a priori knowledge to improve a reliability of the soft bit information;
selecting one of a plurality of indices that has a maximum probability based on the soft bit information; and
decoding the encoded parameter based on the selected index.

6. The method of claim 1, wherein the bit information comprises soft bit information, and wherein decoding the encoded parameter based on the bit information comprises:
weighting each of a plurality of decoded parameters obtained using a corresponding index in a plurality of indices by a probability associated with the corresponding index, the probability being based on the soft bit information; and
combining the weighted decoded parameters to obtain a combined decoded parameter.

7. The method of claim 1, wherein determining if the decoded parameter violates a parameter constraint comprises:
determining if one or more of the encoded parameter and the decoded parameter, and/or a measure of change thereof, exceeds and/or is below one or more thresholds.

8. The method of claim 7, wherein determining if one or more of the encoded parameter and the decoded parameter, and/or a measure of change thereof, exceeds and/or is below one or more thresholds comprises:
determining if a measure of change in a decoded gain exceeds a threshold.

9. The method of claim 7, further comprising:
determining each of the one or more thresholds based on one or more conditional probability density functions, the one or more conditional probability density functions being obtained by observing how one or more of the encoded parameter and the decoded parameter, and/or a measure of change thereof, relates to functions derived from one or more other encoded parameters and/or decoded parameters obtained from the encoded frame or from one or more other encoded frames that represent segments of the signal.

10. The method of claim 1, wherein generating the estimate of the decoded parameter comprises:
identifying one or more bits of the encoded frame that may be in error based on the bit information;
changing the value of the identified one or more bits to generate a new version of the encoded frame;
decoding the encoded parameter within the new version of the encoded frame to obtain a new version of the decoded parameter;
determining if the new version of the decoded parameter violates the parameter constraint; and
using the new version of the decoded parameter as the estimate of the decoded parameter if the new version of the decoded parameter does not violate the parameter constraint.

11. The method of claim 1, wherein generating the estimate of the decoded parameter comprises performing one of prediction, interpolation, extrapolation or repetition based on one or more values of the decoded parameter associated with one or more other encoded frames that represent segments of the signal.

12. A system for performing packet loss concealment in response to a determination that an encoded frame representing a segment of a signal is bad, the system comprising:
bit decoding logic configured to decode an encoded parameter within the encoded frame based on bit information associated with the encoded parameter to obtain a decoded parameter;
parameter constraint logic configured to determine if the decoded parameter violates a parameter constraint, the parameter constraint logic further configured to pass the decoded parameter to a decoder for use in decoding the encoded frame in response to determining that the decoded parameter does not violate the parameter constraint, and to generate an estimate of the decoded parameter and pass the estimate of the decoded parameter to the decoder for use in decoding the encoded frame in response to determining that the decoded parameter does violate the parameter constraint.

13. The system of claim 12, wherein the encoded parameter comprises one of: gain, pitch, line spectral frequencies, pitch gain, fixed codebook gain, and fixed codebook excitation.

14. The system of claim 12, wherein the bit information comprises soft bit information obtained from a channel decoding process.

15. The system of claim 12, wherein the bit decoding logic is configured to decode the encoded parameter by assigning hard bit values obtained from the channel decoding process to an index, and decoding the encoded parameter based on the index.

16. The system of claim 12, wherein the bit information comprises soft bit information, and wherein the bit decoding logic is configured to decode the encoded parameter by:
using a priori knowledge to improve a reliability of the soft bit information;
selecting one of a plurality of indices that has a maximum probability based on the soft bit information; and
decoding the encoded parameter based on the selected index.

17. The system of claim 12, wherein the bit information comprises soft bit information, and wherein the bit decoding logic is configured to decode the encoded parameter by:
weighting each of a plurality of decoded parameters obtained using a corresponding index in a plurality of indices by a probability associated with the corresponding index, the probability being based on the soft bit information; and
combining the weighted decoded parameters to obtain a combined decoder parameter.

18. The system of claim 12, wherein the parameter constraint logic is configured to determine if the decoded parameter violates the parameter constraint by determining if one or more of the encoded parameter and the decoded parameter, and/or a measure of change thereof, exceeds and/or is below one or more thresholds.

19. The system of claim 18, wherein the parameter constraint logic is further configured to determine each of the one or more thresholds based on one or more conditional probability density functions, the one or more conditional probability density functions being obtained by observing how one or more of the encoded parameter and the decoded parameter, and/or a measure of change thereof, relates to functions derived from one or more other encoded parameters and/or decoded parameters obtained from the encoded frame or from one or more other encoded frames that represent segments of the speech signal.

20. A computer program product comprising a computer-readable storage medium having computer program logic recorded thereon for enabling a processing unit to perform packet loss concealment in response to a determination that an encoded frame representing a segment of a signal is bad, comprising:
first means for enabling the processing unit to decode an encoded parameter within the encoded frame based on bit information associated with the encoded parameter to obtain a decoded parameter; and
second means for enabling the processing unit to determine if the decoded parameter violates a parameter constraint and to pass the decoded parameter to a decoder for use in decoding the encoded frame in response to determining that the decoded parameter does not violate the parameter constraint, the second means also for enabling the processing unit to generate an estimate of the decoded parameter and pass the estimate of the decoded parameter to the decoder for use in decoding the encoded frame in response to determining that the decoded parameter does violate the parameter constraint.
